(19) United States
(12) Patent Application Publication
(10) Pub. No.: US 2013/0263728 A1
(43) Pub. Date: Oct. 10, 2013

(54) SHOCK AND IMPACT RESISTANT MULTILAYERED COMPOSITE AND METHOD FOR ITS FABRICATION

(71) Applicant: Eurocopter Deutschland GmbH, (US)

(72) Inventors: Michael Hebensperger, Munich (DE); Wolfgang Kreitmair-Steck, Munich (DE)

(73) Assignee: EUROCOPTER DEUTSCHLAND GMBH, Donauworth (DE)

(21) Appl. No.: 13/664,724

(22) Filed: Oct. 31, 2012

(30) Foreign Application Priority Data
Nov. 2, 2011 (EP) 11 400051.6

(51) Int. Cl. F41H 5/04; B29C 71/02

(52) U.S. Cl. CPC F41H 5/0435; F41H 5/04; F41H 5/0471; F41H 5/0464; F41H 5/0414; B29C 71/02
USPC 89/36.02; 264/241

(57) ABSTRACT

A shock and impact resistant multilayered composite comprising an outer shatter protection body, and at least one active body along side the shatter protection. At least one highly elastic and tearproof absorption/dissipation body is provided along side the at least one active body, said outer shatter protection body being cured to said at least one active body and said at least one active body being cured to said at least one absorption/dissipation body. The present invention relates as well to a method for fabrication of such a shock and impact resistant multilayered composite.

### CROSS REFERENCE TO RELATED APPLICATIONS

This application claims priority to European patent application No. 11 400051.6 filed Nov. 2, 2011, the disclosure of which is incorporated in its entirety by reference herein.

### BACKGROUND OF THE INVENTION

(1) Field of the Invention

The present invention relates to a shock and impact resistant multilayered composite as armour against high velocity projectiles with the features of claim 1 and to a method for fabrication of such an impact resistant multilayered composite with the features of claim 11.

(2) Description of Related Art

Certain types of armour for protecting various structures and machines have been constructed from monolithic ceramic materials. These materials offer advantages in that they can be extremely hard and light weight. The extreme hardness of ceramic armour has advantages in that incoming projectiles can be shattered on impact.

Typically, ceramic armour is made up of numerous, flat monolithic ceramic plates or tiles which are sometimes arranged end to end and attached to the surface which is to be protected, such as for example, on the bottom of an airplane or helicopter to protect these aircraft from ground fire.

Although, armour constructed of monolithic ceramic plates has advantages as described above, it tends to be brittle. Typically, the impact of just one projectile will shatter an entire plate of the monolithic ceramic armour, even those unimpacted areas of the plate adjacent the impact site.

Thus, a large area of the plate is rendered ineffective against subsequent projectiles. In addition, the nature of monolithic ceramic materials and their associated forming methods precludes forming complex shapes or large pieces. Essentially, ceramic armour must be constructed from the aforementioned flat ceramic plates. In the case where ceramic armour is employed on an aircraft, ground vehicle, etc., there can be installation problems associated with attaching numerous flat ceramic plates to a surface that may be curved. In addition, having these numerous small plates attached to the outside of an aircraft can increase the aerodynamic drag.

The document U.S. Pat. No. 6,203,908 B1 discloses a composite armour for absorbing and dissipating kinetic energy from high velocity projectiles, comprising a panel provided with a layer of a plurality of high density ceramic bodies, each of the bodies being substantially cylindrical in shape. The bodies are arranged in a plurality of adjacent rows and columns, the major axis of the bodies being in substantially parallel orientation with each other and substantially perpendicular to an adjacent surface of the panel.

The document U.S. Pat. No. 5,847,308 A discloses a passive armour system using armour stacks of ceramic tiles connected to layers of glass. The armour stacks are then adhered to the inside of a cover box. The cover box is then secured to a base and then covered with a cloth impregnated with an adhesive.

The document WO 03010484 A1 discloses a ceramic armour system including an integral ceramic plate, or a plurality of interconnected ceramic components providing an integral plate. The ceramic has a deflecting front surface or a flat front surface, and a rear surface. A front spall layer is bonded to the front surface of the ceramic plate. A shock-absorbing layer is bonded to the rear surface of ceramic plate. A backing is bonded to the exposed face of the shock-absorbing layer.

The document DE 19831725 C1 discloses an armour plate with a ceramic-carbon fibre composite fixed in a matrix. The composite includes additional carbon fibres which are longer than the short fibres in the main mix and are indiscriminately distributed through the matrix or in the form of a web.

The document U.S. Pat. No. 5,970,843 A discloses an integrated, layered armour structure having multiple layers which alternate in their exhibited characteristics between extremely hard and ductile. The extremely hard layers of the armour structure are designed to shatter an impacting projectile, or pieces thereof, and to fracture in such a way as to dissipate at least a portion of the kinetic energy associated with the projectile pieces and to disperse the projectile pieces and hard layer fragments over a wide area. The ductile layers of the armour structure are designed to yield under the force of impinging projectile pieces and hard layer fragments from an adjacent hard layer. This yielding dissipates at least a portion of the remaining kinetic energy of these pieces and fragments. Pieces and fragments not possessing sufficient kinetic energy to tear through the ductile layer are trapped therein and so stopped.

### BRIEF SUMMARY OF THE INVENTION

It is an object of the present invention to provide a shock and impact resistant multilayered composite as passive armour with optimized absorption and dissipation of any kinematic energy of projectiles upon impact to facilitate stopping the resulting pieces of the projectile from passing completely through the armour and preventing the shattering of adjacent not impacted portions of the armour. It is another object of the present invention to provide a shock and impact resistant multilayered composite as armour with reduced weight that can be formed into practically any shape and size desired, so as to be made to conform to the shape of the structure or machine for improved protection. It is a further object of the present invention to provide a method for fabrication of such a shock and impact resistant multilayered composite.

The above-described objectives are realized with a shock and impact resistant multilayered composite with the features of claim 1 of the present invention and with a method for fabrication of such an impact resistant multilayered composite with the features of claim 11. Preferred embodiments of the invention are provided with the subclaims.

According to the invention a shock and impact resistant multilayered composite as armour against projectiles, particularly for aircrafts, ground- and/or water vehicles, comprises an outer shatter protection body, at least one active body along side the shatter protection, and at least one highly elastic and tearproof absorption/dissipation body along side the at least one active body. The outer shatter protection body is cured to said at least one active body and said at least one active body is cured to said at least one absorption/dissipation body.

According to the invention each of the bodies, namely the outer shatter protection body, said at least one active body or said at least one absorption/dissipation body contribute individually to the improved ballistic protection of the composite. Said outer shatter protection body as an elastomer/fiber composite protects against any damages resulting from fragments of a projectile with high kinetic energy. Any diffusion and the amplitudes of a shock wave are attenuated and reduced in depth and laterally by the bodies to restrain areas of ground material. All of said bodies achieve by their summarized effects a passive armour with optimized absorption and dissipation of any kinematic energy of high velocity projectiles upon impact which allows to facilitate stopping any resulting pieces of the projectile from passing completely through the armour and preventing the shattering of adjacent not impacted portions of the armour.

According to a further advantage of the present invention a shock and impact resistant multilayered composite as armour is provided with reduced weight that can be formed into practically any shape and size desired, so as to be made to conform to any shape of a structure or machine for improved protection. The reduced weight of the inventive shock and impact resistant multilayered composite has low influence on carrying capacity, manoeuvrability, cruising range and/or fuel consumption of any aircraft, ground- and/or water vehicle equipped with said inventive armour.

According to a preferred embodiment of the invention the outer shatter protection body and said at least one absorption/dissipation body each comprise respectively at least one supporting tissue between elastomeric layers on either side. Said outer shatter protection body protects any adjacent ceramic material against any damages resulting from fragments of a projectile with high kinetic energy. The coverage of the supporting tissue by means of elastomeric layers protects the fibers of the supporting tissue from UV-rays and from humidity and thus said coverage allows protection of the material of the supporting tissue from deterioration. The compound structure defined by the at least one supporting tissue between elastomeric layers on either side safeguards the characteristics of the high modular fibers of the supporting tissue in said at least one absorption/dissipation body for a satisfying attenuation of a shock wave. The high modular fibers have an elasticity modulus>100 GPa, are tearproof till>2.5 GPa and have an elongation at break>2.0%.

According to a further preferred embodiment of the invention the at least one supporting tissue is made of high modular fibers with high tensile strength and good linear expansion, said fibers being thermoset liquid crystalline polyoxazole, aramide and/or high-modulus polyethylene (HMPE) or high-performance polyethylene (HPPE).

According to a further preferred embodiment of the invention the outer shatter protection body is coated with a hard plastic layer, such as a hard plastic layer made of ultra high-molecular polyethylene or polyurethane in order to protect the outer shatter protection body from corrosion, particularly if said outer shatter protection body is mounted to the outside of a vehicle.

According to a further preferred embodiment of the invention a metal tissue, such as a copper mesh, is integrated into the hard plastic layer to allow protection against lightning and providing electro-magnetic compatibility.

According to a further preferred embodiment of the invention the at least one active body as a ceramic/elastomer composite comprises at least two ceramic layers joined by means of an elastomeric body. The ceramic layers have the function to deform and/or to fragment the projectiles on impact to facilitate stopping said projectiles or their fragments. The elastomer or rubber allows high absorption of the shock wave due to its sonic speed of not more than 150 m/sec compared to more than 10.000 m/sec in ceramics. The ceramic composites have an elasticity modulus>350 GPa, are tearproof till>0.2 GPa, have a Vickers hardness>20 GPA, a pressure resistance>2.0 GPa and have a variable size between 1 mm-20 mm.

According to a further preferred embodiment of the invention the ceramic layers of the at least one active body are made of the same or different materials, such as aluminium oxide, silicium carbide, silicium enriched silicium carbide, boron carbide, boron nitride, tungsten carbide or ceramic-fiber, carbide fiber or carbon nano tubes (CNT) reinforced ceramics. The fracture bridging effect of the fibers allows higher dynamic loads of the ceramics and reduces any lateral fracture extension.

According to a further preferred embodiment of the invention the ceramic layers of the at least one active body are of the same or different thicknesses, while in the case of different thicknesses preferably the layer with the biggest thickness and highest rigidity being the layer turned towards an impact and subsequent layers are having more and more decreasing thicknesses and/or rigidities.

According to a further preferred embodiment of the invention fiber tissues are provided with high elastic modulus, high tensile strength and high linear expansion between the ceramic layers, said fiber tissues being embedded in the elastomer layers.

According to a further preferred embodiment of the invention at least one thermosetting resin is applied to any of the at least one supporting tissue and/or the elastomeric layers, said at least two ceramic layers and/or elastomeric body, such thermosetting resins being epoxi-resin, polyester-resin, acrylate-resin, phenol-formaldehyde-resin and/or cyanate-ester-resin. The appliance of said thermosetting resin enhances adherence of the layers and adherence of the bodies of the inventive impact resistant multilayered composite.

According to a further preferred embodiment of the invention at least one layer of tissue material, such as carbon fiber, glass fiber, etc., and partly thermosetting synthetic resin are provided in the absorption/dissipation body to allow the necessary stability of the compound structure.

According to a preferred embodiment of the invention a method for fabrication of an impact resistant multilayered composite comprises the steps of preparing an outer shatter protection body, at least one active body and at least one absorption/dissipation body, and hardening and/or curing said outer shatter protection body to said at least one active body and said at least one active body to said at least one absorption/dissipation body. The inventive method allows preparation of an outer shatter protection body, at least one active body and at least one absorption/dissipation body separately and respective hardening and/or curing of each of said bodies separately in an autoclave or hot press. Subsequent a thermosetting resin, such as epoxi-resin, polyester-resin, acrylate-resin, phenol-formaldehyde-resin and cyanate-ester-resin, is applied to any of the bodies that are joined to each other by means of a further heat treatment.

According to a further preferred embodiment of the invention the fabrication of an armour from the inventive impact resistant multilayered composite is accomplished in one common process with the steps of providing a non-adherent, coated mould, charging the mould with layers according to the sequence of the outer shatter protection body, the at least one active body and the at least one absorption/dissipation body, closing the mould and hardening and simultaneously curing at temperatures between 90° C. to 200° C. said outer shatter protection body to said at least one active body and said at least one active body to said at least one absorption/dissipation body by applying pressure and temperature in a hot press. The common process allows simultaneous synthesis of all materials used with improved adherence for the inventive impact resistant multilayered composite.

According to a further preferred embodiment of the invention the fabrication of an armour from the inventive impact resistant multilayered composite is accomplished alternatively in one common process with the steps of providing a non-adherent, coated mould, charging the mould with layers according to the sequence of the outer shatter protection body, the at least one active body and the at least one absorption/dissipation body, and hardening and simultaneously curing said outer shatter protection body to said at least one active body and said at least one active body to said at least one absorption/dissipation body in the open or closed mould by applying temperatures above 110° C. in an autoclave or hot air oven.

According to a further preferred embodiment of the invention the mould is coated with paraffin, silicone, surface-active agent and/or fluorinated hydrocarbon to avoid adherence.

### BRIEF DESCRIPTION OF THE SEVERAL VIEWS OF THE DRAWINGS

The invention will be described with reference to preferred embodiments of the invention as presented in the following description with reference to the drawings. The drawings show in:

FIG. 1 a lateral view of a ceramic armour system according to the state of the art,

FIG. 2 a cross sectional view of an impact resistant multilayered composite according to the invention,

FIG. 3 a cross sectional view of a preferred embodiment of an impact resistant multilayered composite according to the invention,

FIG. 4 a cross sectional view of a further preferred embodiment of an impact resistant multilayered composite according to the invention,

FIG. 5 a cross sectional view of a still further preferred embodiment of an impact resistant multilayered composite according to the invention,

FIG. 6a a top view of a layer of ceramics tiles of a still further preferred embodiment of an impact resistant multilayered composite according to the invention, and

FIG. 6b a cross sectional view of a an curved arrangement of ceramics tiles of a still further preferred embodiment of an impact resistant multilayered composite according to the invention.

### DETAILED DESCRIPTION OF THE INVENTION

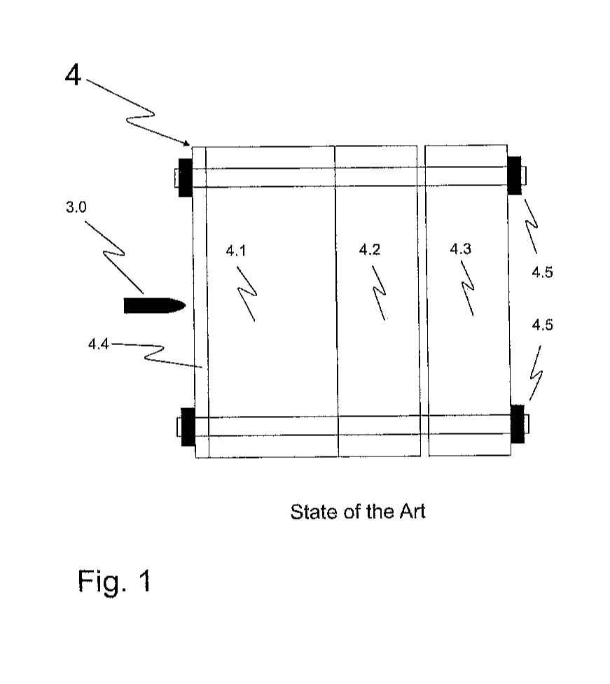

According to FIG. 1 a ceramic armour system 4 as ballistic protection against a projectile 3.0 comprises a cover layer 4.4 protecting against ceramic spall. The ceramic armour system 4 further comprises along side the cover layer 4.4 a ceramic body 4.1 adapted to deform and/or fragment the projectile 3.0 upon impact and for reduction of the speed of the projectile 3.0. Along side the ceramic body 4.1 is mounted an absorption/dissipation body 4.2 for reception of the ceramic spall, the ceramic powder and for the slowed down projectile 3.0 and/or the slowed down fragments of the projectile 3.0. The absorption/dissipation body 4.2 is mounted inside the ceramic body 4.1 and next to a support structure 4.3. The cover layer 4.4, the ceramic body 4.1, the absorption/dissipation body 4.2 and the support structure 4.3 are clamped against each other by parallel bolts 4.5 at lateral ends of the system 4.

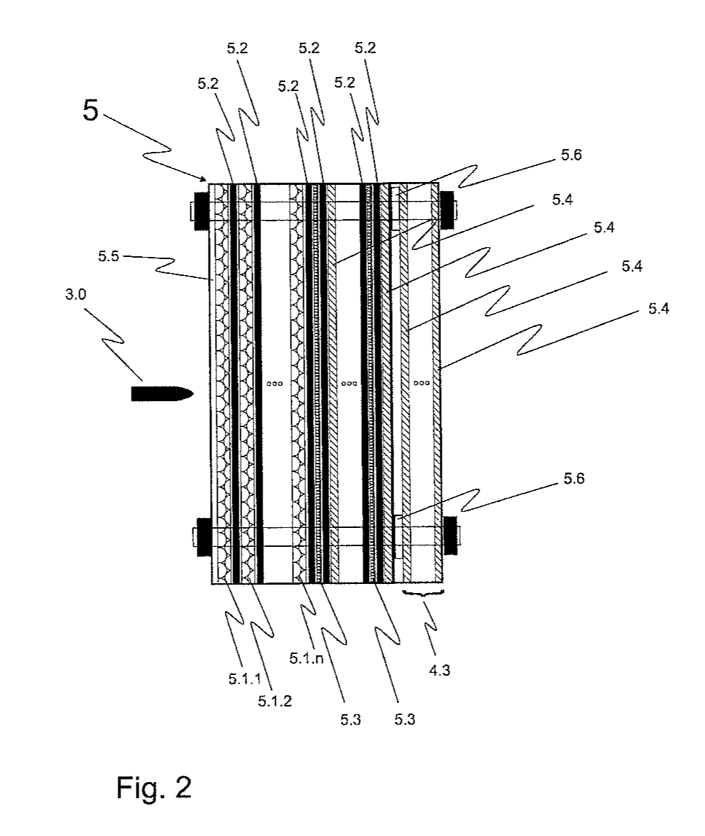

According to FIG. 2 an impact resistant multilayered composite 5 as ballistic protection against a projectile 3.0 comprises an outer shatter protection body 5.5 of one supporting tissue (not shown) between elastomeric layers (not shown) on either side. The supporting tissue is made of high modular fibers with high tensile strength and good linear expansion, said fibers being thermoset liquid crystalline polyoxazole, aramide and/or high-modulus polyethylene (HMPE) or high-performance polyethylene (HPPE).

The outer shatter protection body 5.5 is coated for reduction of drag, to provide a ground for painting and for protection against corrosion with a hard plastic layer (not shown) made of ultra high-molecular polyethylene or polyurethane and a metal tissue (not shown), such as a copper mesh, is embedded alongside the hard plastic layer, said metal tissue protecting against lightning and providing electro-magnetic compatibility for the impact resistant multilayered composite 5.

The impact resistant multilayered composite 5 further comprises along side and inside of the outer shatter protection body 5.5 a composite of a plurality of ceramic layers 5.1.1 to 5.1.n with elastomer layers 5.2 arranged between said ceramic layers 5.1.1 to 5.1.n. The ceramic layers 5.1.1 to 5.1.n are all made of the same material or are made of a suitable selection of different ceramic materials.

Subsequent and along side to the plurality of ceramic layers 5.1.1 to 5.1.n with elastomer layers 5.2 is mounted an absorption/dissipation body for the impact resistant multilayered composite 5. The absorption/dissipation body is composed of elastomer layers 5.2 and supporting tissues 5.3 made of high modular fibers with high tensile strength and good linear expansion and a layer of tissue material, such as carbon fiber, glass fiber, etc., and partly thermosetting synthetic resin 5.4.

A body of layers of tissue material and partly thermosetting synthetic resin 5.4, representing the structure to be protected against the high velocity projectiles 3.0, is arranged along side the absorption/dissipation body and separated by spacers 5.6 from the absorption/dissipation body. The body of layers of tissue material and partly thermosetting synthetic resin 5.4 is clamped to the impact resistant multilayered composite 5 by parallel bolts at lateral ends.

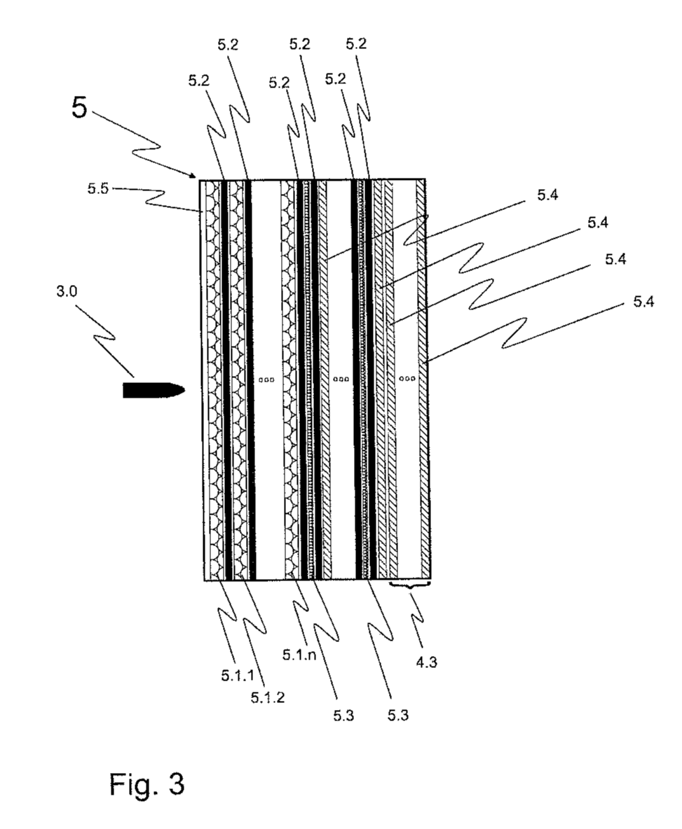

The impact resistant multilayered composite 5 according to FIG. 3 corresponds to the impact resistant multilayered composite 5 of FIG. 2 with the difference that the body of layers of tissue material and partly thermosetting synthetic resin 5.4 forms an overall composite with the impact resistant multilayered composite 5.

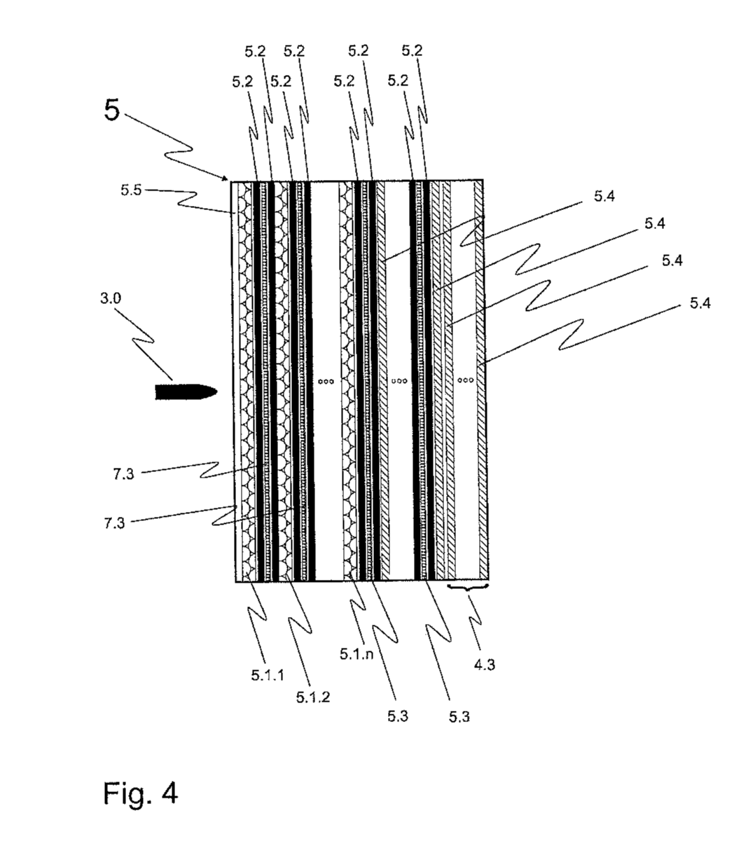

According to FIG. 4 the impact resistant multilayered composite 5 as ballistic protection against a projectile 3.0 comprises an outer shatter protection body 5.5 as defined in FIG. 2 followed inside by a plurality of aligned ceramic layers 5.1.1 to 5.1.n each respectively supported by elastomer layers 5.2 with embedded fiber tissues 7.3 with high elastic modulus, high tensile strength and high linear expansion; said elastomer layers 5.2 with embedded fiber tissues 7.3 being arranged between said ceramic layers 5.1.1 to 5.1.n.

Subsequent and along side to the plurality of ceramic layers 5.1.1 to 5.1.n supported by the elastomer layers 5.2 with the fiber tissues 7.3 follow the plurality of elastomer layers 5.2, supporting tissues 5.3 and a layer of tissue material and partly thermosetting synthetic resin 5.4 of the absorption/dissipation body for the impact resistant multilayered composite 5 mounted to the body of layers of tissue material and partly thermosetting synthetic resin 5.4, representing the structure to be protected against the high velocity projectiles 3.0.

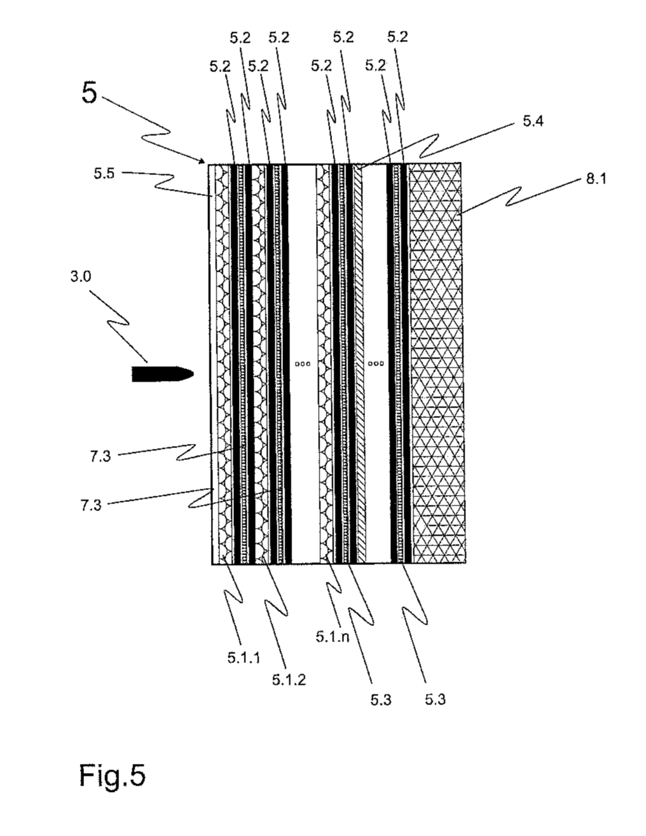

The impact resistant multilayered composite 5 according to FIG. 5 corresponds to the impact resistant multilayered composite 5 of FIG. 4 with the difference that the body to be armoured against the high velocity projectiles 3.0, is a non composite structure, such as a panel sheet 8.1, preferably a metal panel sheet 8.1.

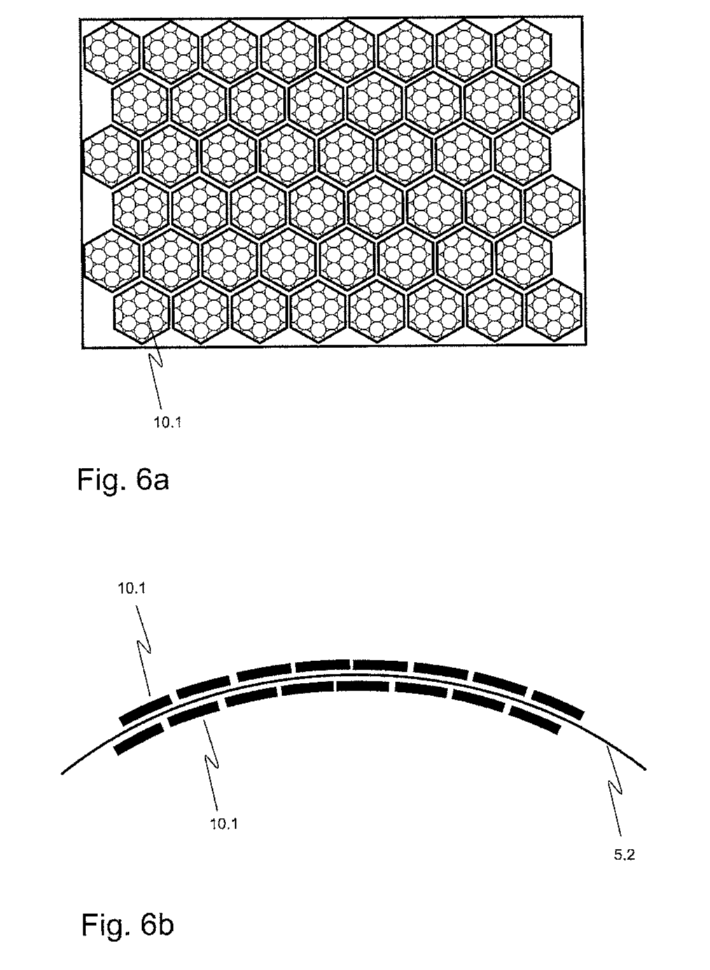

According to FIG. 6a the ceramics layers 5.1.1-5.1.n of the impact resistant multilayered composite 5 are each composed of equilateral hexagonal ceramics tiles 10.1 arranged alongside each other.

According to FIG. 6b the ceramics layers 5.1.1-5.1.n of the impact resistant multilayered composite 5 of equilateral hexagonal ceramics tiles 10.1 of FIG. 6a are arranged in a curved or double curved geometry with sufficiently big curvature radius.

A method for fabrication of an impact resistant multilayered composite

A method for fabrication of an impact resistant multilayered composite 5 comprises in its most general way the steps of preparing an outer shatter protection body 5.5, at least one active body and at least one absorption/dissipation body. Said outer shatter protection body is hardened and/or cured to said at least one active body and said at least one active body is hardened and/or cured to said at least one absorption/dissipation body.

The impact resistant multilayered composite 5 is mounted to a structure 5.4, 8.1 to be protected against high velocity projectiles 3.

Preferably the method for fabrication of an impact resistant multilayered composite 5 comprises providing a non-adherent, coated mould by coating the mould with paraffin, silicone, surface-active agent and/or fluorinated hydrocarbon. The non-adherent, coated mould is charged with ceramic layers 5.1.1 to 5.1.n, with elastomer layers 5.2, supporting tissues 5.3, layers of tissue material and partly thermosetting synthetic resin 5.4 and/or elastomer layers 5.2 with embedded fiber tissues 7.3 according to the sequence defined by the outer shatter protection body, the at least one active body and the at least one absorption/dissipation body. The mould is closed and said outer shatter protection body is hardened and simultaneously cured to said at least one active body and said at least one active body is hardened and simultaneously cured to said at least one absorption/dissipation body by applying pressure and temperatures in a range of 90° C. to 200° C. in a hot press (not shown).

Alternatively the preferred method for fabrication of an impact resistant multilayered composite 5 comprises providing the non-adherent, coated mould, charging the non-adherent, coated mould is charged with the ceramic layers 5.1.1 to 5.1.n, the elastomer layers 5.2, supporting tissues 5.3, layers of tissue material and partly thermosetting synthetic resin 5.4 and/or elastomer layers 5.2 with embedded fiber tissues 7.3 according to the sequence defined by the outer shatter protection body, the at least one active body and the at least one absorption/dissipation body. The outer shatter protection body is hardened and simultaneously cured to said at least one active body and said at least one active body is hardened and simultaneously cured to said at least one absorption/dissipation body in the opened or closed mould at temperatures above 110° C. in an autoclave or a hot air oven (not shown).

1. A shock and impact resistant multilayered composite comprising an outer shatter protection body, and
at least one active body along side the shatter protection, characterized in that at least one highly elastic and tearproof absorption/dissipation body is provided along side the at least one active body, said outer shatter protection body being cured to said at least one active body and said at least one active body being cured to said at least one absorption/dissipation body.

2. The composite according to claim 1, wherein the outer shatter protection body and said at least one absorption/dissipation body each comprise at least one supporting tissue between elastomeric layers on either side.

3. The composite according to claim 2, wherein the at least one supporting tissue is made of high modular fibers with high tensile strength and good linear expansion, said fibers being thermoset liquid crystalline polyoxazole, aramide and/or high-modulus polyethylene (HMPE) or high-performance polyethylene (HPPE).

4. The composite according to claim 2, wherein the outer shatter protection body is coated with a hard plastic layer, such as a hard plastic layer made of ultra high-molecular polyethylene or polyurethane.

5. The composite according to claim 4, wherein a metal tissue, such as a copper mesh, is integrated into the hard plastic layer.

6. The composite according to claim 1, wherein the at least one active body comprises at least two ceramic layers joined by means of an elastomeric body.

7. The composite according to claim 6, wherein the ceramic layers of the at least one active body are made of the same or different materials, such as aluminium oxide, silicium carbide, silicium enriched silicium carbide, boron carbide, boron nitride, tungsten carbide or ceramic-fiber or carbide fiber or carbon nano tubes (CNT) reinforced ceramics.

8. The composite according to claim 6, wherein the ceramic layers of the at least one active body are of the same or different thicknesses, while in the case of different thicknesses preferably the layer with the biggest thickness and highest rigidity being the layer turned towards an impact and subsequent layers are having more and more decreasing thicknesses and/or rigidities.

9. The composite according to claim 6, wherein fiber tissues (7.3) with high elastic modulus, high tensile strength and high linear expansion are provided between the ceramic layers (5.1.1 to 5.1.n) said fiber tissues (7.3) being embedded in the elastomer layers (5.2).

10. The composite according to claim 2, wherein at least one thermosetting resin is applied to the at least one supporting tissue and/or the elastomeric layers, said at least two ceramic layers and/or elastomeric body, such thermosetting resins being epoxi-resin, polyester-resin, acrylate-resin, phenol-formaldehyde-resin and/or cyanate-ester-resin.

11. The composite according to claim 2, wherein the at least one layer of tissue material, such as carbon fiber, glass fiber, etc., and partly thermosetting synthetic resin are provided in the absorption/dissipation body.

12. The composite according to claim 6, wherein each layer of ceramics is composed of a geometrical arrangement of ceramic tiles.

13. A method for fabrication of a shock and impact resistant multilayered composite comprising at least: one outer shatter protection body, one active body along side the outer shatter protection body, one highly elastic and one tearproof absorption/dissipation body provided along side the active body; the outer shatter protection body being cured to the active body and the active body being cured to the tearproof absorption/dissipation body, wherein the method includes:
preparing the outer shatter protection body, the active body and
a plurality of tearproof absorption/dissipation bodies, and
hardening and/or curing the outer shatter protection body to the active body and the active body to the plurality of tearproof absorption/dissipation bodies.

14. The method according to claim 13, comprising:
providing a non-adherent, coated mould,
charging the mould with layers according to the sequence of the outer shatter protection body, the at least one active body and the at least one absorption/dissipation body,
closing the mould and
hardening and simultaneously curing said outer shatter protection body to said at least one active body and said at least one active body to said at least one absorption/dissipation body by applying pressure and temperature in a hot press.

15. The method according to claim 13, comprising:
providing a non-adherent, coated mould,
charging the mould with layers according to the sequence of the outer shatter protection body, the at least one active body and the at least one absorption/dissipation body, and
hardening and simultaneously curing said outer shatter protection body to said at least one active body and said at least one active body to said at least one absorption/dissipation body by applying temperatures above 110° C. in an autoclave or hot air oven.

16. The method according to claim 13, further comprising:
coating the mould with paraffin, silicone, surface-active agent and/or fluorinated hydrocarbon.
